(19) United States
(12) Patent Application Publication
(10) Pub. No.: US 2008/0108330 A1
(43) Pub. Date: May 8, 2008

(54) Methods, systems and computer products for notification to a remote party of mobile party presence status change

(76) Inventors: Douglas O'Neil, Marietta, GA (US); Stephen Sherman, Alpharetta, GA (US)

Correspondence Address: CANTOR COLBURN LLP - BELLSOUTH, 20 Church Street, 22nd Floor, Hartford, CT, 06103, US

(21) Appl. No.: 11/593,940

(22) Filed: Nov. 7, 2006

(51) Int. Cl. H04M 3/42

(52) U.S. Cl. 455/414.1

(57) ABSTRACT

Methods, systems and computer products for notifying a customer if particular telephone numbers are in communication with the mobile network, when a status change has occurred, and the use of network intelligence to track the reason for the status change. Exemplary embodiments include a method for providing a mobile network status change notification service, including establishing a status change notification relationship between a device and the mobile network, monitoring the device for a status change on the network, detecting a reason for the change in state status and diagnosing the status change.

### BACKGROUND

The present disclosure relates generally to mobile network notification services and in particular, to a method of notifying a customer if particular telephone numbers are in communication with the mobile network, when a status change has occurred and the use of network intelligence to track the reason for the status change.

Cellular telephones provide convenience and safety to customers by giving customers the ability to make and receive telephone calls from any location where cellular services are available. The ability to receive telephone calls is limited to the times when the telephone is turned on. When the telephone is turned off, a caller will normally receive an announcement provided by the cellular service provider, or carrier, that the customer is currently unavailable or is not within a service area. With some systems, a caller calling when a customer's telephone is turned off will be able to leave a voice message for the customer. The customer can then retrieve such a message by calling into the service provider. Currently, a caller cannot tell if a customer's telephone is turned on and connected to the mobile network without calling the customer's telephone number. Furthermore, a caller cannot tell if a customer's telephone has undergone a presence status change.

### BRIEF SUMMARY

Exemplary embodiments include a method for providing a mobile network status change notification service, including establishing a status change notification relationship between a device and the mobile network, monitoring the device for a status change on the network, detecting a reason for the change in state status and diagnosing the status change.

Additional exemplary embodiments include a system for providing a mobile network status change notification service, including a network, a device in communication with the network and a status change notification application residing on at least one of the network and the device, the status change notification application monitoring the device for a status change.

Further exemplary embodiments include a computer-readable medium having computer-executable instructions for performing a method including establishing a status change notification relationship between a mobile network and a device in communication with the mobile network, monitoring the device for a status change on the network, detecting a reason for the change in state status, diagnosing the status change; and generating a status change notification on the network, including the reason for the status change.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram of an exemplary system for providing a mobile network status change notification service;

FIG. 2 depicts an exemplary customer interface for providing a mobile network status change notification service;

FIG. 4 depicts an exemplary process by which a customer may provision a status change notification service when the notification application is implemented through a browser application that resides on a server;

FIG. 5 depicts alternate exemplary embodiments that may be utilized to allow a customer to provision portions of a status change notification service through an application that resides partially in the customer telephone and partially on a server;

FIG. 6 depicts an exemplary telephone call process for utilizing a mobile network status change notification service;

FIG. 7 depicts an exemplary status change notification process; and

FIG. 8 depicts an exemplary telephone call process for utilizing a mobile network status change notification service.

The detailed description explains the exemplary embodiments, together with advantages and features, by way of example with reference to the drawings.

### DETAILED DESCRIPTION OF EXEMPLARY EMBODIMENTS

Exemplary embodiments of the present invention provide the ability for a mobile telephone customer of a provider network to know when another mobile customer of the provider network (or another provider network that has partnered with the provider network or partnering Internet Service Providers (ISP's)) has their telephone turned on in the mobile network, and to know when the other mobile customer has had a status change on the network. Given this knowledge, the mobile telephone customer may then call the other mobile customer or send the other mobile customer a message using an instant messaging facility or can alternatively track the other mobile user on the basis of network intelligence. The ability to determine if another mobile customer has their telephone turned on in the mobile network may be provided by a network based solution utilizing a browser for provisioning. Alternatively, this ability may be provided by utilizing software that communicates with the provider network and has been loaded into a cellular telephone (e.g., at point of purchase, downloaded, flash upgrade). Exemplary embodiments of the present invention create an option for a mobile telephone customer who enters a telephone number into the telephone memory to allow other mobile subscriber customers to see when the customer's telephone is powered on and within the mobile network, and alternatively to allow other who enters a telephone number into the telephone memory to allow other mobile subscriber customers to see when and how the customer's telephone has undergone a status change.

In exemplary embodiments of the present invention, the status change notification service may be supported by utilizing the information that is communicated to a home location register (HLR) or location server regarding the status of mobile subscribers. A modification to the existing software on an HLR may be written to manage this, or alternatively an additional server may be created to specifically manage the status of mobile customers. Software is installed on customer telephones to run the status change notification application. The status change notification application manages the list of the individual mobile customers and their status. The application also communicates with the mobile network to send and receive status updates. The application further utilizes various network intelligence to provide specific information on how and why a status change has occurred. Using this information, other locating tracking abilities are contemplated.

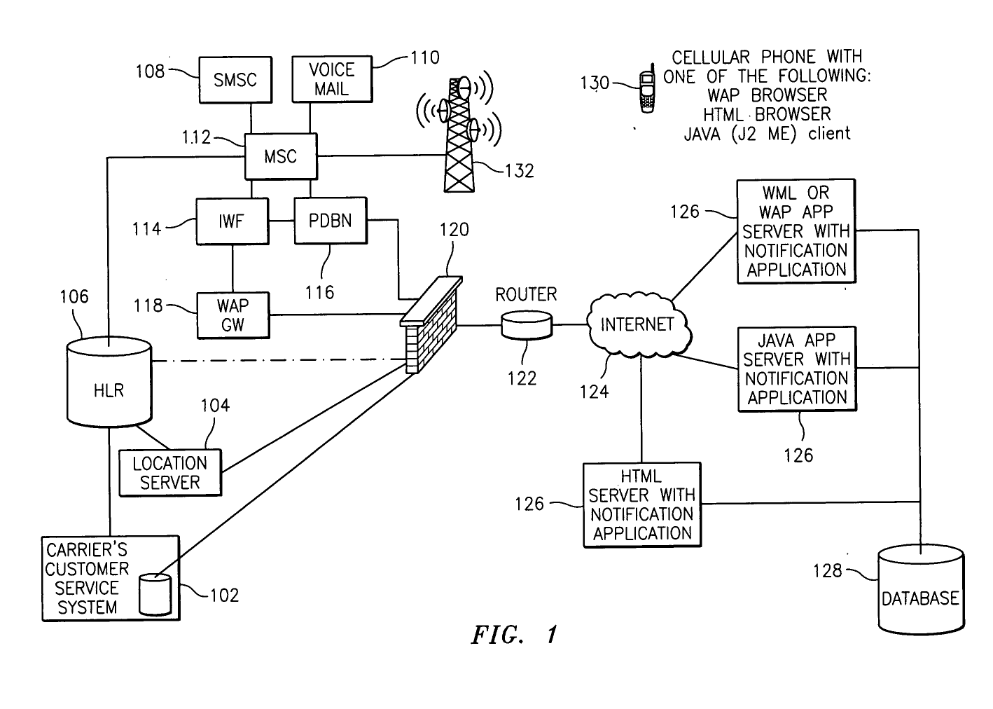

FIG. 1 is a block diagram of an exemplary system for providing a mobile network status change notification service. The system includes a cellular telephone 130 containing connection software such as a wireless application protocol (WAP) browser or a hypertext markup language (HTML) browser when the status change notification application resides on an application server 126. Alternatively, the cellular telephone 130 may include a Java client (e.g. J2ME, binary runtime environment for wireless (BREW), other similar client) or any other type of client known in the art when portions of the notification application reside in the cellular telephone 130 and other portions of the notification application reside on an application server 126. The system depicted in FIG. 1 includes a standard wireless telephone network environment with elements including a base station 132 for receiving telephone calls from cellular telephones 130, a mobile switching center (MSC) 112 in communication with a short messaging service center 108 (SMSC), a voice mail system 110, a home location register 106 (HLR), an IWF 114 and a packet data backbone network 116 (PDBN). The IWF 114 is also in communication with a wireless application protocol gateway 118 (WAP GW).

The HLR 106, as is known in the art, includes a database of customer (subscriber) information including customer profiles utilized in mobile (cellular) networks. In addition, the HLR 106 accesses customer information from the carrier's customer service system 102 and a location server 104. In exemplary embodiments of the present invention, the HLR 10 records whether the customer is a subscriber to the notification service. If the customer is a subscriber, the HLR 106 sends a message to the status change notification application via a network 124, such as the Internet, when the customer telephone 130 is powered on and in the mobile network. In exemplary embodiments of the present invention, the HLR 106 sends information to the status change notification application through a firewall 120 and via a router 122 and the network 124.

In alternate exemplary embodiments, the location server 104 extracts base station 132, or cell site, location information from the HLR 106 and device specific location information (e.g., GPS based location) from the device, or telephone 130. The location server 104 may then make this location information available to the application servers 126. Alternatively, the HLR 106 may take the location information from the location server 104 and send it to the application servers 126.

The network 124 depicted in FIG. 1 may be any type of known network including, but not limited to, a wide area network (WAN), a local area network (LAN), a global network (e.g. Internet), a virtual private network (VPN), and an intranet. The network 124 may be implemented using a wireless network or any kind of physical network implementation known in the art.

FIG. 1 also includes a database for storing status change notification application data. The storage device 128 depicted in FIG. 1 may be implemented using a variety of devices for storing information. It is understood that the storage device 128 may be implemented using memory contained in one or more of the server systems 126 or it may be a separate physical device. The storage device 128 is logically addressable as a consolidated data source across a distributed environment that includes a network 124. The physical data accessed via the storage device 128 may be located in a variety of geographic locations depending on application and access requirements. Information stored in the storage device 128 may be retrieved and manipulated via the server systems 126. The storage device 128 includes a status change notification database. In exemplary embodiments, the status change notification database is relational and includes one or more records correlating a mobile telephone customer with other mobile telephone customers that have allowed the mobile telephone customer to view their current mobile telephone status. The storage device 128 may also include other kinds of data such as information concerning the creating and modification of the status change notification database records (e.g., date and time of creation). In exemplary embodiments, one or more of the server systems 126 operate as a database servers and coordinate access to application data including data stored on storage device 128.

Storage device 128 can further include physical location data, such as data provided by global positioning systems (GPS) and advanced forward link trilateration (AFLT), and whether or not and to whom a subscriber has allowed this physical position information. Storage device 128 can further include moment-to-moment physical location data as to where someone is positioned as well as their “rabbit tracks”, that is the trail that shows where a person has been up to a point in time. In general, storage medium can store information related to three GPS satellites, which in turn pinpoints position, which can be sent to location server 104 and stored in storage device 128. In general, the device 130 calculates it's position with an algorithm and sends that to location server 104 in the network 124 and then that server 104 in the network 124 can make that available to those that have permission.

As discussed further in the description below, if device 130 does not see three satellites, but rather just one or two, the device 130 can inform the server 104 that the device 130 is still on the network 124, but only sees limited satellites. The device 130 can further acknowledge that it is being sent a location request from location server 104. As such, the device 130 can provide additional intelligence, that is, in this case, the ability to see only limited satellites, to the location server 104, which can subsequently be stored in storage device 128. At any time, location server can have access to a last known position.

Without specific location information, location server 104 can fall back on AFLT, which, as mentioned above, is a trilateration based on cell ID, or falls back to cell area. As such, using a combination of last known position based on the previously seen GPS satellites, in combination with the presently known cell, a reasonably accurate position can be attained. In the alternative, trilateration can be implemented to determine position. Therefore, if a requestor is asking for detailed position, which is not available, the location server 104 can provide position based on the combination of last known GPS position in combination with cell ID or trilateration. The requester can then receive a statement of this position and how it was determined. A thorough response from the location server would then include an acknowledgement of presence on the network, with an explanation of the accuracy of the position based on the network intelligence available.

Therefore, a user with a device 130 having location and presence capabilities not only provides information about the user's location or presence, but also provides a remote notification of changes in the status of that user's device 130. For example, a notification can automatically be generated if three normally available GPS satellites that provide reasonably accurate position-related information, are no longer available. Further status change notification examples can include, but are not limited to: device 130 is out of range; device 130 has been turned off voluntarily; device 130 battery has died; a level of privacy has been invoked on the device 130, the device 130 has traveled out of the network; the device 130 is still within the network, but in a dead spot; whether the device 130 is exceeding a pre-determined speed; the device 130 has been configured to deny the requester information; 911 has been dialed, etc.

In an exemplary implementation, a requester may want to know a particular area through which a device 130 is traveling, and receive a notification if a predetermined path has been altered. For example, a user could be a delivery person traveling a predetermined route. The requester could then have a predetermined parameter or profile that generates an alert if the predetermined parameter or profile has been altered.

It is therefore appreciated that status change notification application 126 not only provides location monitoring, but also provides a notification when a known physical location is no longer known. The location server 104 then invokes a portion of the application 126 that indicates that the device 130 is no longer available and provides the reasons why the device 130 is no longer available based on the network intelligence as described. Therefore, the location server 104 via the status change notification application 126 looks at the raw data that was available to the location server 104 and it's also going to query into the subscriber database of the mobile network. By performing both of these analyses, the location server 104 can gather information and then have a logical determination of what has happened to device 130. For example, the kind of information location server 104 would receive from the subscriber database is whether or not the device is still known to be registered on the mobile network. If there was a de-registration, the location server 104 can obtain the de-registration notification information. The location server 104 could further obtain information related to a power-down, such as by voluntary means, by a dead battery, by signal degradation (and still on the network, but the signal is so weak that we're having trouble communicating but it hasn't deregistered yet), etc. Therefore, in this example, the location server 104 can make a determination such as follows: device 130 was in a position close to the edge of the network coverage based on a particular cell site. Then the location server 104 can obtain the additional information from the HLR 106 and can determine with relative certainty that the device 130 traveled outside of the network.

Therefore, a relevant notification can be sent back to the requester of the information because the requestor of the info can know that he has requested a location, know where the device 103 has been, but now does not know the location of the device 130, and can obtain information as to why the device 130 is not available, which can be a reasonable determination of position. In the aforementioned example, the requester can know that the device 130 has traveled out of the network. The requestor therefore can look at the history of the “rabbit tracks” and then can also conclude that the device 130 is in a remote location Status change notification application 126 can further make a prediction, using the cell site information, last known position from GPS, HLR data, and cell and sector data available on the mobile network cell and sector. For example, if the device 130 is moving through a tunnel, it is likely to lose GPS entirely, and the rabbit tracks may stop, but the predicted path is the next 2 miles before the device 130 sees GPS again, or the next 5 miles before the device 130 sees GPS again.

In exemplary embodiments, database 128 or another information database, can further include information on known dead spots, as mentioned in the previous example with respect to a tunnel. Further network intelligence can therefore include, a known speed of device 130 and the knowledge of a known dead spot, such as a 2-mile long tunnel. Therefore, with speed at last known GPS position, and the known dead spot, the requester can obtain a likely direction, area and time of a futreu location. With additional knowledge of highways, roads, etc, which can reside in database 128, or an additional database, potential change of directions can also be determined.

By querying a “dead spot” database, cellular carriers can also automatically tweak the RF in their network a couple times a year, particularly if they're in areas where there's heavy foliage due to changes the RF characteristics. The dead spot database can therefore include signal level tied to GPS position. As part of an ongoing diagnosis of status change, the status change notification database 128 can query the known dead spots with the last known physical location of the device 130, perform a search of the area, then be able to determine whether the device 130 left the network completely, drove out of the network coverage area completely or is positioned within a known dead spot.

In another example, if there is intelligence that the device 130 is detected out of range, or has no signal, or not registered, right, status change notification application 126 can start a timer with instructions that indicate if the device 130 is out of range for a predetermined amount of time or for a period set by the requester, then the requestor can be notified periodically that the device 130 is still out of range. The timer can be further used in conjunction with a last known speed to determine the distance traveled in a period of time. By knowing time and speed, distance can be calculated and position predicted. Therefore, if a certain position has not been attained after a timer period, a further status change notification can be generated. In a more general sense, a timer can be set after an indication that the user has undergone a status change, and if the status has not changed back within the period, a notification can be generated. Therefore, the timer can create a delay or a threshold for a notification to be generated.

The application servers 126 execute one or more computer programs to facilitate the notification process. The processing is described in more detail below and may include having all of the notification application residing on the server 126 or sharing the processing of the notification application between the server 126 and the cellular telephone 130. All or portions of the notification application may be located on a server 126 such as a wireless markup language (WML) or wireless application protocol (WAP) server, an HTML server, a Java application server, or a BREW application server. In exemplary embodiments of the present invention, portions of the notification application may also be located on the cellular telephone 130.

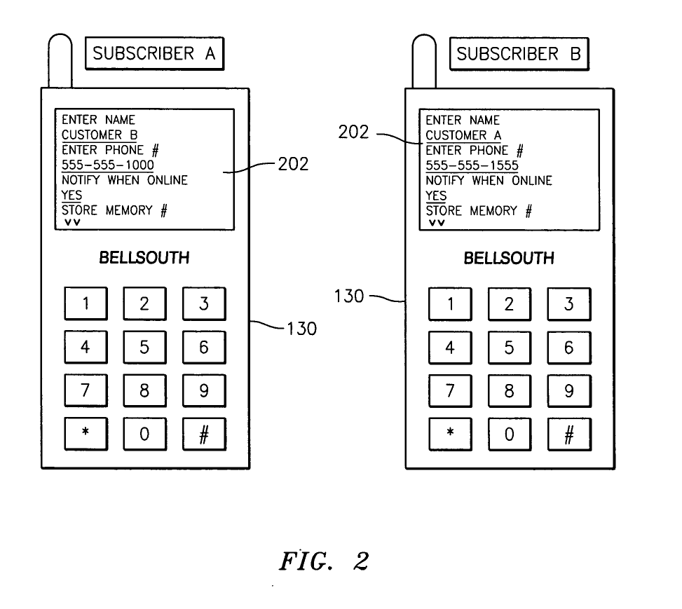

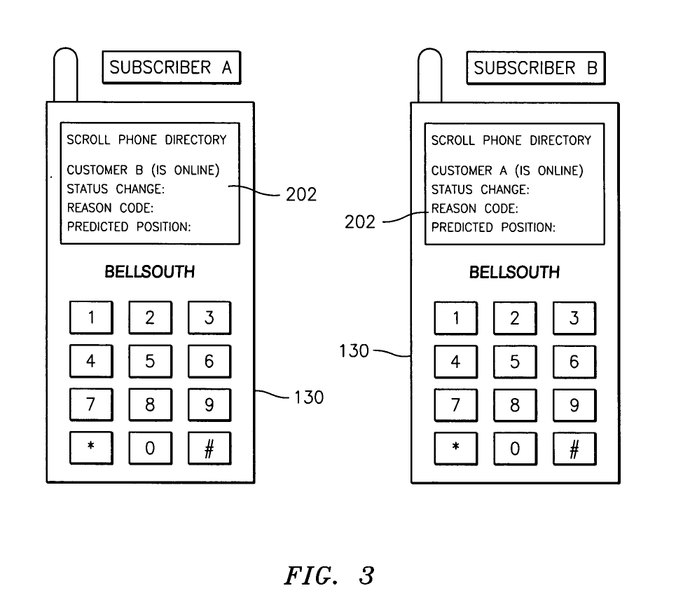

FIG. 2 depicts an exemplary customer interface for providing a mobile network notification service. Exemplary embodiments send and receive updates to and from the mobile network regarding the availability status and the change of status including informative information of the status change using network intelligence, of other mobile customers. For example, as depicted in FIG. 2, Subscriber A and Subscriber B can load each other's telephone number into both of their telephones 130. Subscriber A's telephone communication area 202 includes Subscriber B's name, telephone number and instructions to notify Subscriber B when Subscriber A is connected to the mobile network, and when a status change has occurred, including reasons for the status change. Similarly, Subscriber B's telephone communication area 202 includes Subscriber A's name, telephone number and instructions to notify Subscriber A when Subscriber B is connected to the mobile network and when a status change has occurred, including reasons for the status change. In addition, Subscriber B processes screens in the telephone communication area 202 to request that status change notification of Subscriber A and vice-versa. In response to processing these screens, the status change notification service application checks 126 the status of Subscriber A and Subscriber B periodically to determine status changes of their telephones 130.

FIG. 3 depicts an exemplary customer interface for providing a mobile network notification service. After the notification service application processes the screen described in reference to FIG. 2, the telephone communication areas 202 on the subscriber telephones 130 contain information about the availability status of the other subscriber. The telephone communication areas 202 can further contain alert information that a status change has occurred, a reason code, which can be an actual text statement of the reason as discussed above, or a numerical code that corresponds to one of the reasons discussed above. The telephone communication area 202 can further include a predicted position map based on the processes and algorithms discussed above. A requester can then send the user an instant message or may make a telephone call to the other as a follow-up regarding the status change. In an alternate exemplary embodiment of the present invention, either subscriber may also determine an approximate physical location of the other. As discussed, if there has been a status change and the physical location cannot be determined from normally available network intelligence, a predicted position can be determined as discussed above. The status change notification application may obtain this information via the location server 104.

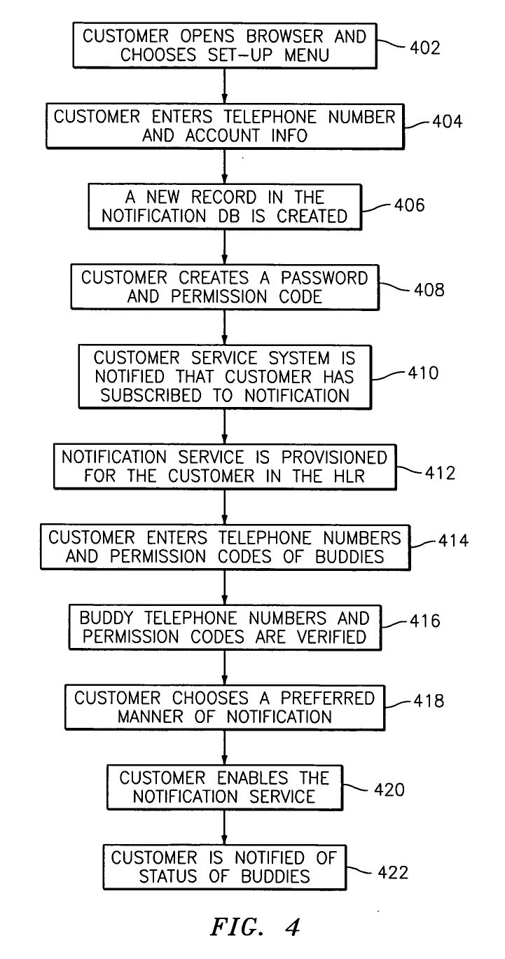

FIG. 4 depicts an exemplary process by which a customer may provision a status change notification service when the status change notification application is implemented through a browser application that resides on a server 126. The result of this process is that the mobile telephone customer has established a status change notification list that includes other mobile telephone customers whose status the mobile telephone customer tracks. Another result is that the status change notification list is enabled and therefore the status is tracked and communicated to the mobile telephone. The mobile telephone customer establishes a status change notification list via a web page, which may be implemented in HTML, WAP, WML or other type of browser known in the art. In other exemplary implementations, specific status change notification protocols can be established. For example, parents can set up status change notification application to track their children and provide status change notifications, timers, etc., as discussed above.

At step 402, the mobile telephone customer opens the browser and selects the set-up menu for the status change notification application from the options presented in the communication area 202 on the customer telephone 130. Next, at step 404, in response to the status change notification application request, the customer enters his telephone number and information about the customer account that uniquely identifies the customer. The status change notification application then verifies the telephone number and customer information against data contained in the customer service system 102 database. If the information is not valid, then an error message is sent to the customer telephone communication area 202 via the browser and the customer is again asked to enter a telephone number and identification information. After a pre-selected number of failed attempts, the customer is advised to contact customer service.

Once the information entered by the customer is verified, step 406 is performed to create a new record in the status change notification database located on the storage device 128. Next, at step 408, the customer creates a customer password and permission code in response to prompting from the notification application displayed in the telephone communication area 202. The customer password allows the customer to make changes to their status change status change notification application profile (e.g., changing the notification list, disabling/enabling the status change notification application, deactivating the feature, setting timers, setting status change reason code assignments, status change notification preference, etc.). The status change notification application adds the customer password to the profile of the customer in the status change notification database located on the storage device 128. The permission code allows other customers to add the customer to their “buddy list.” The status change notification application adds the permission code entered by the customer to the profile of the customer in the status change notification database. At step 410, the customer service system 102 is notified that the customer has subscribed to the status change notification service.

Next, at step 412, the status change notification service is provisioned for the customer in the HLR 106. The status change notification service may be provisioned in the HLR 106 via “class of service” or similar means. In exemplary embodiments, the class of service for the status change notification feature includes a “registration trigger” and a “de-registration trigger.” The telephone 130 powers on and registers to the network, then the cases of service for this feature enables the registration trigger and sends a message to the status change notification application, located on a server 126, that the telephone is turned on and active in the network. As discussed above, the registration and de-registration can be used to determine a reason for status change. When the telephone 130 is turned off and de-registers from the network, the class of service for this feature enables the de-registration trigger and sends a message to the status change notification application that the telephone is turned off and no longer active on the network.

At step 414, the customer enters the telephone numbers and permission codes of other customers to be added to the customer's notification list in response to prompting by the status change notification application. The status change notification application requests the customer, via the telephone communication area 202, to enter the telephone number of another customer (i.e., a “buddy”). For security reasons, the customer must know a permission code associated with the telephone number of the buddy. The status change notification application requests the customer to enter the permission code associated with the buddy. At step 416, the status change notification application verifies that the telephone number and permission code for the buddy are valid by making a query to the status change notification database located on the storage device 128. If the telephone number/permission code combination entered by the customer is not valid, then an error message is sent to the customer telephone communication area 202 via the browser. The error message is displayed on the customer's telephone communication area 202. After a pre-selected number of failed attempts, the notification application tells the customer to contact their buddy and verify the permission code or call customer service. In exemplary embodiments, a subscriber can set up a “buddy list” specific to a family or other individuals whose position and presence status change are of particular interest, such as children.

The customer enters a preferred manner of status change notification at step 418 in response to prompts from the status change notification application. The status change notification application looks at the browser code for the current session and determines if the browser is associated with a mobile device and if it has “push” capability. The status change notification application queries the customer service system 102 and determines if the subscriber has short message service (SMS) supported by a SMSC 108 and voice mail 110. The status change notification application then presents the choices for status change notification to the customer in the customer telephone communication area 202 located on the customer telephone 130. In exemplary embodiments, the status change notification application presents the choices for notification to the customer in the following order, depending on the device capability of the telephone 130 and features to which the customer has subscribed: push notification via the browser or if the customer does not have a browser with this capability, the notification will be via a web page for the customer; SMS push notification; SMS pull notification; voice mail. The customer may choose one or more of these options for notification. It is appreciated that in other exemplary embodiments and implementations, a customer can select among other devices for notification, such as a personal computer, and other methods of status change notification, such as email, instant message, audio files, etc.

Next, at step 420, the customer enables the status change notification service in response to a prompt from the status change notification application in the telephone communication area 202. The customer may request that the application be enabled automatically each time the customer powers on the telephone 130. Alternatively, the customer may manually enable the application through a menu in the telephone communication area 202 located on the customer's telephone 130. When the status change notification application is enabled, the application sets a flag in the notification database to show that the customer has enabled it, and a step 422, the application notifies the customer of all buddies who are on the cellular telephone network and who have enabled their status change notification application in the preferred manner(s) selected by the customer. In exemplary embodiments, a customer can typically choose among the buddies who the customer wishes to track for status change and position. This selection can be made each time the phone is powered, or can be pre-selected or modified during device use.

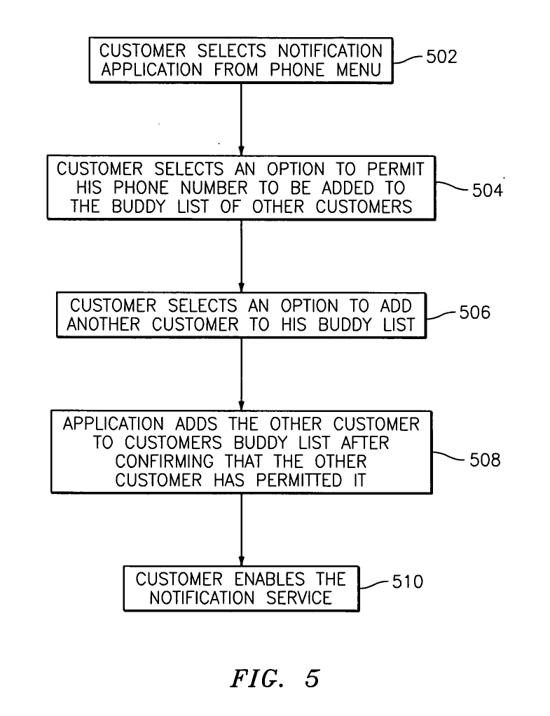

FIG. 5 depicts alternate exemplary embodiments that may be utilized to allow a customer to provision portions of a status change notification service through an application that resides partially in the customer telephone 130 and partially on a server 126. The status change notification application may be installed in the telephone 130 during manufacture or it may be downloaded into the telephone 130 on a JAVA (e.g., J2ME) application or similar download application. The status change notification application contains the address book for the customer and the ability to communicate with network components to know if any of the telephone numbers in the address book are active on the network at any time, and which of the numbers have experienced a presence status change. The customer may enter telephone numbers in the address book using the status change notification application located on the telephone 130. The status change notification application gives the customer the option to make the telephone number just entered part of the “buddy list.” The customer also has an option in the menu of the telephone 130 to permit his number to be added to the status change notification list of other customers. In addition, the customer has the ability to use the menu of the telephone to enable or disable the status change notification feature. When the feature is enabled, all other buddies who have enabled the notification feature receive a notification when their “buddies” turn on their telephones 130 (register to the network). Also, they receive notification when their “buddies” sign off of the network. The basic notification of signing on and off can include “normal” reason codes. For other reasons as discussed, network intelligence can be queried and reasons can be provided.

Referring still to FIG. 5, where the application is split between a telephone 130 and a server 126, the customer may request the location of his “buddies” who are active on the network. The client application in the telephone 130 accesses the host application in the server 126, then the application in the server 126 extracts the location information of the “buddy” from the location server 104. The application in the server 126 updates the location of the “buddy” in the database 128 and sends the information to the client application in the telephone 130 of the user who requested the location information. The application in the client telephone 130 displays the location information associated with the “buddy.” In the event that the “buddy” is not active on the network, the application server 126 accesses network intelligence to determine the best prediction of the position of the “buddy”, and the reason the “buddy” is not available.

Referring to FIG. 5, establishing a status change notification list with the address book on the customer telephone 130 begins at step 502 when the customer selects the status change notification application from the menu on the customer telephone 130. At step 504, the customer selects an option to permit the customer telephone number to be added to the notification list of other customers. In an exemplary implementation, the permission occurs among members who desire to know any presence status change of the other members, such as family members. This selection may be limited to specific telephone numbers or to any telephone number that knows the permission code associated with the customer. When the customer selects the option to turn on permission, the status change notification application in the telephone sends an update to the server application residing on a server 126. The first time that the customer turns on permission, the server application creates a new record in the status change notification database located on the storage device 128 and informs the customer service billing system that the customer has activated this feature. The server application updates the customer profile in the status change notification database 128 to indicate that the customer has permitted his number to be added to other customers' “buddy lists.”

At step 506, the customer selects an option to add another user to the customer's “buddy list.” When the customer creates or accesses the telephone number of another customer, the customer may enable an option to add the telephone number to the customer's “buddy list.” At step 508, the telephone portion of the status change notification application adds the other customer to the customer's notification list after confirming that the other customer has permitted the status change notification. The status change notification application in the telephone 130 then sends the updated status change notification list information to the server application located on an application server 126. The server application checks the status change notification database 128 for the new telephone number that the customer wants to add to the status change notification list and confirms that the owner of this telephone number has permitted this customer to add the number to his “buddy list.” If the telephone number has permission to be added to the customer status change notification list, the server application updates the customer profile in the database with the new “buddy list.” In addition, the server application instructs the portion of the status change notification application located in the telephone 130 to illuminate an icon next to the telephone number in the address book, to indicate that the number is on the “buddy list.” In an exemplary implementation, the icon can blink, change color, or otherwise change appearance if a status change has occurred, as an additional alert to another user that the status change has occurred. If the number does not have permission to be added to the customer “buddy list,” the server application sends to a message to the telephone communication area 202 of the customer telephone 130 that says that the owner of the telephone number has not granted permission to add this number to the status change notification list or that the owner of this telephone number does not use the status change notification service.

The customer may enable the status change notification service at step 510 by using an option in the telephone 130. When the application is enabled or disabled, the status change notification application located in the telephone 130 sends a message to the server status change notification application. The server status change notification application updates the customer profile in the status change notification database to show the status of status change notification application for this customer as either enabled or disabled. As discussed above, by enabling or disabling the status change notification application, a status change notification is generated to those customers who have permission and who are monitoring the status change of the device.

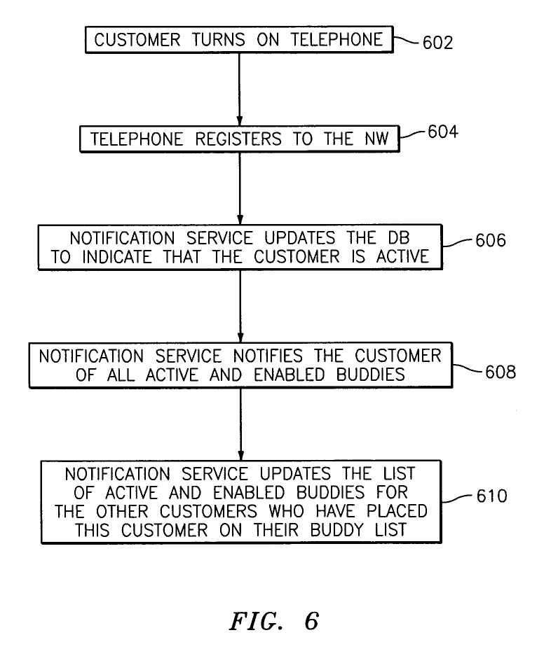

FIG. 6 depicts an exemplary telephone call process for utilizing a mobile network status change notification service. At step 602, the customer powers on the telephone 130 and at step 604, the telephone 130 is registered to the network. As part of registering to the network, the HLR 106 sets a record to indicate that the telephone 130 is on the network. Next, at step 606, the status change notification service updates the status change notification database, located on the storage device 128, to indicate that the customer is active. As discussed above, the powering on of the phone indicates a status change and thus a status change notification is generated to those customers monitoring status change of the device. In exemplary embodiments, the HLR 106 has a feature that is associated with the status change notification application. This feature is a class of service or similar means. The class of service for this feature has a registration trigger and a de-registration trigger. When the telephone 130 turns on and registers to the network, the class of service for this feature enables the registration trigger and sends a message to the status change notification application that the telephone 130 is powered on and active on the network. When the status change notification application is split between the telephone 130 and a server 126, the message is sent to the server portion of the status change notification application. The status change notification application (server portion when portions of the application reside on the telephone 130) updates the customer profiles in the notification database to indicate that the customer is active on the telephone network and then it queries the database to see if the status change notification application is enabled. If the status change notification application has not been enabled at this point, then the customer must manually enable the application by opening the status change notification application from the menu located in the telephone communication area 202 of the telephone 130 and choosing the option to enable the status change notification application.

At step 606, the status change notification service updates the status change notification database to indicate that the customer is active. The status change notification application (server portion when portions of the application reside on the telephone 130) scans the status change notification list for the customer and checks the profile of all of the customers on the status change notification list to see which have enabled the application and which also have telephones that are active on the network. If portions of the status change notification application reside in the telephone 130, then the server application sends a message to the application in the telephone 130 that illuminates the icons next to the telephone numbers of all active and enabled “buddies” associated with the customer's “buddy list.” In exemplary implementations, the icons can be selectively enabled to indicate a change, as mentioned above, to indicate that a status change has occurred. In other exemplary implementations, only a limited number of icons are displayed and changes to the icons can occur when status changes occur.

In alternate exemplary embodiments, which include having the status change notification application located on a server 126 and accessed via a browser, the status change notification application creates a list of all active and enabled “buddies” associated with the customer's “buddy list.” The application notifies the customer of the list of all active and enabled “buddies” using one of the following manners as defined in the customer profile in the notification database: the application makes this list available to the customer on a web page; using the push capability in the browser, the application send the list of active and enabled “buddies” to the customer; using the SMS feature, the application sends the list via SMS; or using the voice mail system 110, the application creates a voice record of the list and makes this available as a menu feature in the voice mail system. As discussed above, it is further contemplated that when a status change is generated, the status change notification can be generated via other capabilities such as an instant message, email, etc.

At step 610, the status change notification service (server portion when portions of the application reside on the telephone 130) updates the list of active and enabled “buddies” for the other customers who have place list customer on their “buddy list.” If the customer turns off their telephone 130, the class of service feature utilizes the de-registration trigger and sends a message to the host application that the customer has turned off their telephone 130. The status change notification application (server portion when portions of the application reside on the telephone 130) updates the customer profile in the status change notification database to show that the customer is no longer active on the network. In addition, the status change notification application (server portion when portions of the application reside on the telephone 130) notifies all other customers that have placed this customer on their notification list that this customer is not available. If the customer manually disable the notification feature, and the status change notification application is split between the telephone 130 and a server 126, then the application in the telephone sends a message to the server application to disable the status change notification feature. The status change notification application (server portion when portions of the application reside on the telephone 130) updates the customer profile in the status change notification database to show that the feature is not enabled for this customer. Also, the status change notification application (server portion when portions of the application reside on the telephone 130) sends a message to the customers who have placed this customer on the status change notification list to generate a change to the icon next to this customer's telephone number to indicate that the customer is not available. An associated reason code is further generated using the network intelligence. As desired, the customer can view a predicted position of the customer who just left the network.

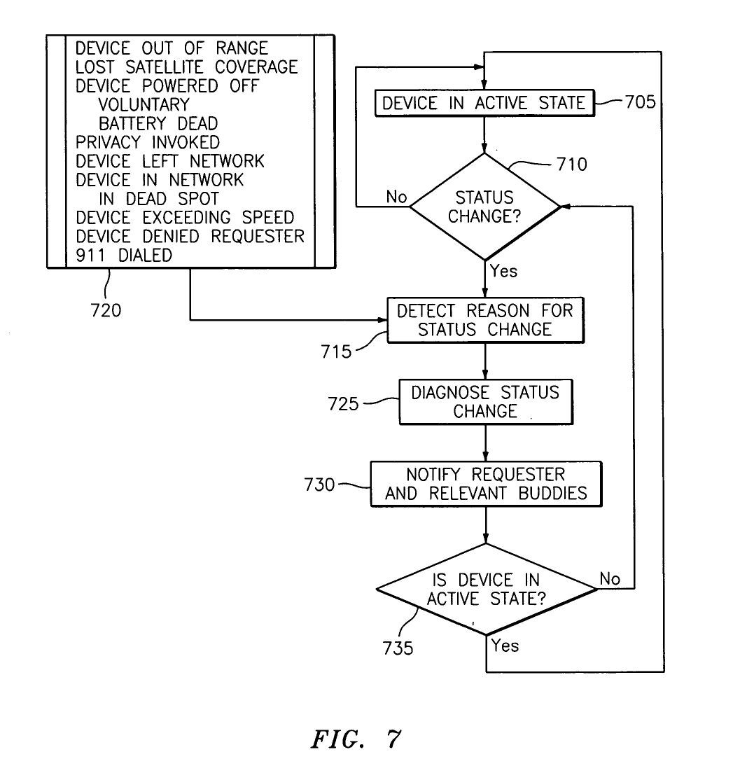

FIG. 7 depicts an exemplary status change notification process. In the exemplary embodiments described herein, reference has been made to the status change notification application 126, which monitors the device 130 and provides status change notifications to the requester. The process under which status change notification application 126 runs is now described.

At step 705, the device 130 is a normal active state. At step 710, the status change notification application 126 monitors the device 130 to determine whether or not there has been a status change. If no status change has occurred, then the status change continues to monitor the device 130 at step 705. If there has been a status change at step 710, then the status change notification application 126 detects the reason for the status change. In general, as discussed above, several predetermined reasons for the status change can be provided at step 720. The reasons for the status change can include, but are not limited to: device 130 is out of range; the device 130 has lost satellite coverage; the device 130 is powered off, which can be a voluntary power-down or it can be due to a dead battery; the user of the device 130 has invoked privacy; the device 130 has left the network; the device 130 is in the network, but is in a known dead spot; the device 130 is exceeding a speed limit, which can be predetermined by the requester; the device 130 has denied the requester monitoring for status change; the device 130 has dialed 911 (or other emergency call), etc. As discussed above, network intelligence can be queried in order to determine the reason.

At step 715 a complete diagnosis is performed, which can include an analysis network intelligence, including, but not limited to: predicted position; GPS locations; known dead spots; cell ID, etc. At step 730, the status change notification application 126 generates a notification to the requester or other buddies, as discussed above. The status change notification application 126 then determines whether or not the device 130 has become active again at step 735. If the device 130 has not become active then the status change notification application 126 checks for any additional status change at step 710, which includes repeating detection at step 715, diagnosis at step 725 and notification at step 730. If the device has once again entered an active state at step 735, then the status change notification application continues monitoring the deice 130 at steps 705, 710, as discussed above. It is appreciated that this process can continually repeat the steps so long as the device 130 is under status change notification status. The continual monitoring at step 710 allows active monitoring so long as the status change notification services are enabled.

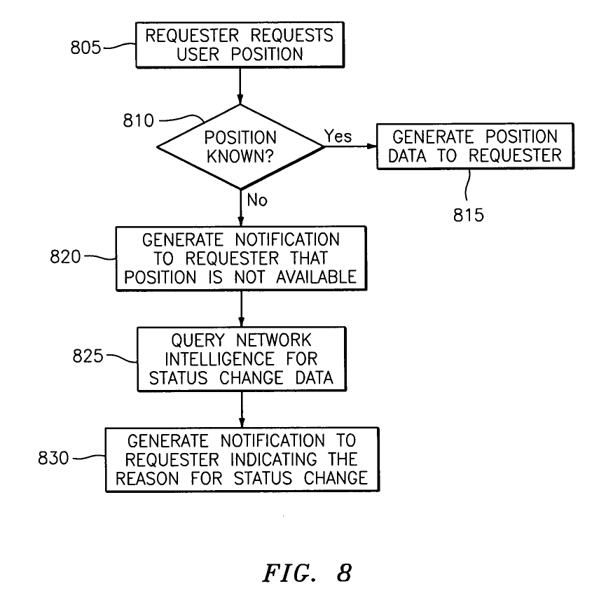

FIG. 8 depicts an exemplary telephone call process for utilizing a mobile network status change notification service. The process depicted in FIG. 8 can be implemented when a requester makes a specific request for position. For example, when the requester receives a status change notification as discussed above, the requester may access the portion of the notification device on screen 202 (See FIGS. 2 and 3) to access a map for locating a position, last known position or a predicted position. It is appreciated that a request for position can take place without a status change, in response to receiving a status change notification, as an ongoing request during a time where the device 130 is not in an active state, etc.

At step 805, the requester requests the device 130 position as discussed. At step 810, if the position of the device 130 is known, then the position date is generated and provided to the requester at step 815. If the position is not known at step 810, for reasons as discussed above, a notification is generated to the requester that the position is not know at step 820. At step 825, the network intelligence can be queried to determine status change data as discussed. At step 830, a notification can be generated to the requester indicating the reason for the status change.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for providing a mobile network status change notification service, comprising:
establishing a status change notification relationship between a device and the mobile network;
monitoring the device for a status change on the network;
detecting a reason for the change in state status; and
diagnosing the status change.

2. The method as claimed in claim 1 further comprising generating a status change notification on the mobile network.

3. The method as claimed in claim 2 wherein the status change notification comprises the reason for the change in the state status.

4. The method as claimed in claim 3 wherein the status change notification comprises network intelligence supporting the reason for the change in the state status.

5. The method as claimed in claim 1 wherein the reason for the change in the state status includes at least one of: the device is out of range; the device has lost a satellite coverage; the device is voluntarily powered off; the battery in the device has failed; the privacy has been invoked on the device; the device has left the network; the device is in a known dead spot; the device is exceeding a predetermined speed limit; the device has denied monitoring for status change; and the device has made an emergency call.

6. The method as claimed in claim 1 further comprising providing a position of the device to the network.

7. The method as claimed in claim 6 further comprising providing a status change notification to an additional device on the network.

8. The method as claimed in claim 6 wherein the position is at least one of: an actual position; a last-known position; and a predicted position.

9. The method as claimed in claim 6 wherein the position is a predicted position based on a combination of at least one of: a GPS location; a cell ID; a known dead-spot; a known road; and trilateration.

10. A system for providing a mobile network status change notification service, comprising:
a network;
a device in communication with the network; and
a status change notification application residing on at least one of the network and the device, the status change notification application monitoring the device for a status change.

11. The system as claimed in claim 10 further comprising a status change notification server coupled to the network, the server processing status change notifications generated by the status change notification application.

12. The system as claimed in claim 11 wherein the server processes reasons for the status change.

13. The system as claimed in claim 12 wherein the reasons include at least one of: the device is out of range; the device has lost a satellite coverage; the device is voluntarily powered off; the battery in the device has failed; the privacy has been invoked on the device; the device has left the network; the device is in a known dead spot; the device is exceeding a predetermined speed limit; the device has denied monitoring for status change; and the device has made an emergency call.

14. The system as claimed in claim 10 further comprising a coverage database coupled to the network.

15. The system as claimed in claim 14 wherein the coverage database includes known dead spots of coverage.

16. The system as claimed in claim 14 further comprising a known roads database coupled to the network.

17. The system as claimed in claim 10 further comprising:
means for generating a status change notification on the network; and
means for providing a position of the device.

18. A computer-readable medium having computer-executable instructions for performing a method comprising:
establishing a status change notification relationship between a mobile network and a device in communication with the mobile network;
monitoring the device for a status change on the network;
detecting a reason for the change in state status;
diagnosing the status change; and
generating a status change notification on the network, including the reason for the status change.

19. The computer readable medium as claimed in claim 18, wherein the method further comprises providing a position of the device based on data available on the network.
